(19) United States
(12) Patent Application Publication
(10) Pub. No.: US 2019/0186723 A1
(43) Pub. Date: Jun. 20, 2019

(54) LED LIGHT STRING CONTROL SYSTEM AND METHOD

(71) Applicant: Dongguan Rongsheng Electronic Industrial Co., Ltd., Dongguan (CN)

(72) Inventor: Huarong Xie, Dongguan (CN)

(21) Appl. No.: 15/871,792

(22) Filed: Jan. 15, 2018

(30) Foreign Application Priority Data
Dec. 14, 2017 (CN) 201711336627.4

(51) Int. Cl. F21V 23/00; H05B 33/08

(52) U.S. Cl. CPC F21V 23/001; H05B 33/0842; H05B 33/0806

(57) ABSTRACT

The present application discloses an LED light string control system, which comprises a power management unit and an electrodeless changeable output unit and an LED light string circuit. The present application further discloses an LED light string control method which comprises: a power management unit providing a direct-current voltage for a system; an electrodeless changeable output unit outputting a polarity voltage with a specific frequency according to a timing sequence; and an LED lamp with the corresponding polarity in the LED light string circuit being lighted according to the polarity voltage.

### CROSS-REFERENCE TO RELATED APPLICATION

This application is based upon and claims priority to Chinese Patent Application No. 201711336627.4, filed on Dec. 14, 2017, the entire contents of which are incorporated herein by reference.

### TECHNICAL FIELD

The present disclosure relates to the technical field of LED lamp control, and in particular to an LED light string control system and method.

### BACKGROUND

LED light source has characteristics of high luminous efficiency, small size, narrow spectrum, long service life and the like, and by utilizing these characteristics, a quality and intelligent lighting environment may be created. Researches have found that light source color temperature of the lighting environment plays a specific role in physiological function adjustment of the human body, but the most comfortable sunlight color temperature for the human being is constantly changing in one day over time. On the other hand, in some special occasions, such as the museum, the hospital, the showroom and the like, a person also needs a lighting control system capable of adjusting the light source color temperature according to actual demands.

In the existing LED circuit control techniques, mainly one positive output line and a plurality of negative output lines are included, each negative output line is connected with negative terminals of one LED lamp group, and positive terminals of multiple LED lamp groups are commonly connected with the positive output line. Such an LED light string wire connection manner has such defects that many wires are used, the structure is complex and costs are high.

Chinese Patent Application No. CN201610166211 discloses a forward-reverse connection type LED light string. The LED light string comprises a controller and an LED module, wherein the LED module comprises at least two LED lamp groups, and further comprises a main line I and a main line II; the at least two LED lamp groups are in series connection between the main line I and the main line II; and each LED lamp group comprises multiple LED lamp beads connected in parallel in a forward-reverse alternating manner. If the LED light string comprises a hundred of LED lamp beads, and such a connection manner may be utilized: every ten LED lamp beads are in forward-reverse parallel connection to form one LED lamp group, and ten LED lamp groups are in series connection. According to such a connection manner, although circuit connection of the LED light string is simplified, the circuit connection is still relatively more complex. Based on the document of this patent, it may be seen that: if a certain number of LED lamps are in parallel connection and then in series connection, a control manner of the LED lamps is still complex, and at least three wires are needed to connect each parallel-connection LED lamp group in series, so the costs are relatively higher.

### SUMMARY

A technical problem to be solved by the present disclosure is to provide a novel LED light string control system and method by aiming at problems that the existing LED light string circuit has a complex structure and relatively higher maintenance and production costs, wherein an electrodeless changeable output unit is configured to output a specific-polarity voltage to an LED light string circuit according to a timing sequence instruction, two adjacent LED lamps in the LED light string circuit have opposite polarities so as to form a forward-reverse connection circuit, and after the LED light string circuit obtains the specific-polarity voltage, LED lamps with the corresponding polarity are lighted. The LED light string forward-reverse connection circuit provided by the present disclosure replaces the traditional multiple-wire LED light string circuit and has the advantages that the production procedure is simplified, production costs are largely reduced, the structure is simple, and maintenance is convenient.

According to the first embodiment, a novel LED light string control system is provided, which comprises a power management unit, wherein the novel LED light string control system further comprises an electrodeless changeable output unit and an LED light string circuit, and the electrodeless changeable output unit is respectively electrically connected with the power management unit and the LED light string circuit.

In particular, the power management unit is used for providing direct-current voltage for the LED light string control system; and the electrodeless changeable output unit is configured to output a polarity voltage with a specific frequency to the LED light string circuit according to a timing sequence, wherein two polarity voltage output ports are arranged at an output end of the electrodeless changeable output unit, two polarity voltage input ports are arranged at an input end of the LED light string circuit, and the polarity comprises two polarities, namely a positive polarity and a negative polarity.

Preferably, the two polarity voltage output ports respectively are a first polarity voltage output port and a second polarity voltage output port, the two polarity voltage input ports respectively are a first polarity output input port and a second polarity voltage input port, and the first polarity voltage output port and the second polarity voltage output port are electrically connected with both the first polarity input port and the second polarity input port.

According to the second embodiment, the first polarity voltage input port is arranged on a first polarity connecting wire of the LED light string circuit, the second polarity voltage input port is arranged on a second polarity connecting wire of the LED light string circuit, the first polarity connecting wire is electrically connected with the second polarity connecting wire, and the LED lamps are in parallel connection between the first polarity connecting wire and the second polarity connecting wire and arranged among the first polarity connecting wire and the second polarity connecting wire.

According to the third embodiment, the number of the LED lamps is larger than 2.

According to the fourth embodiment, the polarities of any two adjacent LED lamps are opposite to each other.

According to the fifth embodiment, the electrodeless changeable output unit comprises an instruction input module, an MCU and a polarity voltage output port module, and the MCU is electrically connected with both the instruction input module and the polarity voltage output port module; and the instruction input module is used for outputting a control instruction and a timing sequence instruction to the MCU, and the MCU controls the polarity voltage output port module to output changed-polarity voltages with specific frequencies to the first polarity voltage output port and the second polarity voltage output port.

According to the sixth possible implementation manner, the electrodeless changeable output unit is one selected from the group consisting of a direct-current power supply electrodeless changeable output unit, a battery pack series electrodeless changeable output unit or a solar series electrodeless changeable output unit.

Furthermore, a novel LED light string control method is provided, which comprises: a power management unit provides direct-current voltage for the system; an electrodeless changeable output unit outputs a polarity voltage with a specific frequency according to a timing sequence; and according to the polarity voltage, LED lamps with the corresponding polarity in the LED light string circuit are lighted, wherein two polarity voltage output ports are arranged at an output end of the electrodeless changeable output unit, two polarity voltage input ports are arranged at an input end of the LED light string circuit, and the polarity comprises two polarities, namely a positive polarity and a negative polarity.

In particular, the step that an electrodeless changeable output unit outputs a polarity voltage with a specific frequency according to a timing sequence comprises: an instruction input module inputs a control instruction of a polarity voltage with a specific frequency into the MCU in advance; and the MCU controls the polarity voltage output port to process the inputted power supply voltage to obtain a group of specific-polarity voltages and respectively transmits the voltages to the two polarity voltage output ports.

According to the novel LED light string control system and method provided by the present disclosure, the electrodeless changeable output unit is configured to output the specific-polarity voltage to the LED light string circuit according to the timing sequence instruction, two adjacent LED lamps in the LED light string circuit have opposite polarities so as to form the forward-reverse connection circuit, and after the LED light string circuit obtains the specific-polarity voltage, LED lamps with the corresponding polarity are lighted. The LED light string forward-reverse connection circuit provided by the present disclosure replaces the traditional multiple-wire LED light string circuit and has the advantages that the production procedure is simplified, production costs are largely reduced, the structure is simple, and maintenance is convenient. When sweep frequency for the changed polarity according to the timing sequence is larger than 24 Hz, that is, LED lamps with all polarities are lighted at the same time, a decorative effect of the LED light string circuit is achieved.

### BRIEF DESCRIPTION OF THE DRAWINGS

In order to more clearly illustrate the technical solutions of the embodiments of the present disclosure, the following drawings will be briefly described in connection with the embodiments, and it will be obvious that the drawings in the following description are only some of the present disclosure and it will be apparent to those skilled in the art that other drawings may be obtained without departing from the scope of the inventive work in accordance with these drawings.

FIG. 1 is a schematic diagram of logic assembly connection of an embodiment of a novel LED light string control system provided by the present disclosure.

FIG. 2 is a schematic diagram of an embodiment of port connection of the novel LED light string control system provided by the present disclosure.

FIG. 3 is a schematic diagram of logic connection of an embodiment of an electrodeless changeable output unit in the novel LED light string control system provided by the present disclosure.

FIG. 4 is a schematic diagram of port connection of an embodiment of an electrodeless changeable output unit powered by a direct-current power supply in the novel LED light string control system provided by the present disclosure.

FIG. 5 is a schematic diagram of port connection of an embodiment of an electrodeless changeable output unit powered by a battery pack series in the novel LED light string control system provided by the present disclosure.

FIG. 6 is a schematic diagram of port connection of an embodiment of an electrodeless changeable output unit powered by a solar series in the novel LED light string control system provided by the present disclosure.

FIG. 7 is a schematic diagram of port connection of a first embodiment of an LED light string circuit in the novel LED light string control system provided by the present disclosure.

FIG. 8 is a schematic diagram of port connection of a second embodiment of an LED light string circuit in the novel LED light string control system provided by the present disclosure.

FIG. 9 is a schematic diagram of port connection of a third embodiment of an LED light string circuit in the novel LED light string control system provided by the present disclosure.

FIG. 10 is a schematic diagram of a step flow of an embodiment of a novel LED light string control method provided by the present disclosure.

FIG. 11 is a schematic diagram of a sub-step flow of a step S2 in the novel LED light string control method provided by the present disclosure.

In the drawings, numeric symbols are as follows: 10—direct-current power supply; 20—electrodeless changeable output unit; 21—instruction input module; 22—MCU; 23—polarity voltage output port module; port a—first polarity voltage output port; port b—second polarity voltage output port; 30—LED light string circuit; port A—first polarity voltage input port; and port B—second polarity voltage input port.

### DESCRIPTION OF THE EMBODIMENTS

To make the purpose, technical scheme and advantages of the disclosure more clearly understood, the disclosure is described in further detail below in conjunction with accompanying drawings and embodiments. It should be understood that the specific embodiments described below are merely to illustrate, but to limit, the disclosure.

### Example 1 System

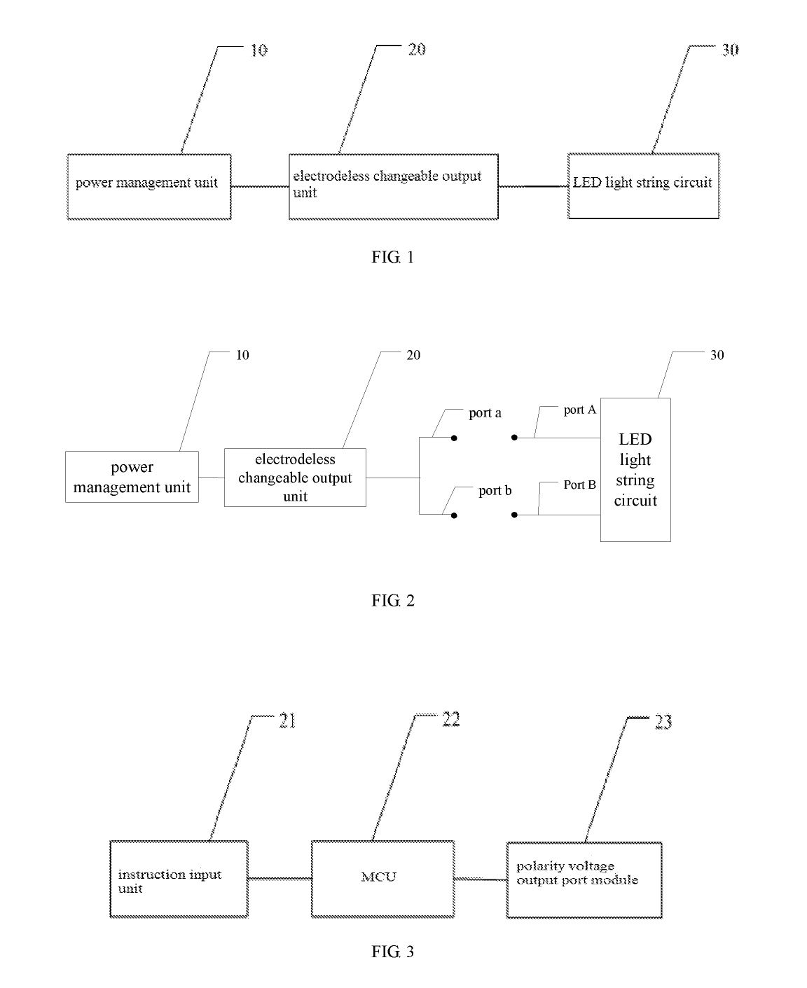

Referring to FIG. 1, FIG. 1 is a schematic diagram of logic assembly connection of an embodiment of a novel LED light string control system provided by the present disclosure. A novel LED light string control system is provided by aiming at problems that the existing LED light string circuit has a complex structure and relatively higher maintenance and production costs. The system comprises a power management unit 10, an electrodeless changeable output unit 20 and an LED light string circuit, and the electrodeless changeable output unit 20 is respectively electrically connected with the power management unit 10 and the LED light string circuit, wherein two polarity voltage output ports are arranged at an output end of the electrodeless changeable output unit 20, two polarity voltage input ports are arranged at an input end of the LED light string circuit, and the polarity comprises two polarities, namely a positive polarity and a negative polarity. In the present disclosure, an LED light string forward-reverse connection circuit adopts a two-wire control circuit, so that the structure is simple, maintenance is convenient, the traditional multiple-wire LED light string circuit is replaced, a production procedure is simplified, and production costs are largely reduced.

In particular, the power management unit 10 is used for providing direct-current voltage for the novel LED light string control system; and the electrodeless changeable output unit 20 is used for outputting a polarity voltage with a specific frequency to the LED light string circuit according to a timing sequence, wherein the human eyes recognize a gradual change effect of LED lamps when the specific frequency is smaller than 24 Hz, and when the specific frequency is larger than or equal to 24 Hz, the changing frequency is larger than the resolution frequency of the human eyes, that is, all LED lamps are lighted, so that specific decorative effects may be achieved by changing the sweep frequency according to demands during practical use.

It should be known by those skilled in the art that: in the present disclosure, the electrodeless changeable output unit 20 is used for outputting the polarity voltage with the specific frequency according to the timing sequence, the main function of the electrodeless changeable output unit 20 is to make the processed direct-current voltage generate polarity change, and because the electrodeless changeable output unit 20 is connected with the LED light string circuit, LED lamps in the LED light string circuit are lighted by the changed-polarity voltage. Therefore, any equivalent substitutions for making the unit perform the same function should all fall within the protection scope of the present disclosure.

Referring to FIG. 2, FIG. 2 is a schematic diagram of an embodiment of port connection of the novel LED light string control system provided by the present disclosure. The two polarity voltage output ports are arranged at the output end of the electrodeless changeable output unit 20, and specifically, the two polarity voltage output ports respectively are a first polarity voltage output port and a second polarity voltage output port. If supposing that the polarity voltage output ports respectively are a port a and a port b, the port a and the port b are used for outputting the processed polarity voltage, and the processing may be described to process the voltage, for example, one light string circuit including multiple LED lamps needs to increase the input polarity voltage in order to meet requirements on the brightness, and the above-mentioned two output ports are correspondingly electrically connected with the two input ports of the LED light string circuit.

The two polarity voltage input ports are arranged at the input end of the LED light string circuit, and specifically, the two polarity voltage input ports respectively are a first polarity voltage input port and a second polarity voltage input port. If supposing that the polarity voltage input ports respectively are a port A and a port B, and control wires, on which the port A and the port B are respectively located, respectively are a wire A and a wire B, the wire A and the wire B are connected. It should be known by those skilled in the art that: the wire A and the wire B are connected to form a semienclosed direct-current circuit, and the port A and the port B are two ports with different polarities. The port a and the port b are respectively and correspondingly connected with the port A and the port B.

Furthermore, the first polarity voltage input port (the port a) is arranged on a first polarity connecting wire of the LED light string circuit, the second polarity voltage input port (the port b) is arranged on a second polarity connecting wire of the LED light string circuit, the first polarity connecting wire and the second polarity connecting wire are electrically connected, and LED lamps are in parallel connection between the first polarity connecting wire and the second polarity connecting wire. The number of the LED lamps in parallel connection is larger than 2, and any two adjacent LED lamps have opposite polarities; and the LED lamps with the opposite polarities are alternatively in parallel connection in the LED light string circuit in order to achieve the changing decorative effect. It should be known by these skilled in the art that forward-reverse control in the present disclosure may be described as follows.

Any two adjacent LED lamps have opposite polarities, as shown in FIG. 7; and FIG. 7 is a schematic diagram of port connection of a first embodiment of an LED light string circuit in the novel LED light string control system provided by the present disclosure.

Any one group of LED lamps and an adjacent LED lamp have opposite polarities, as shown in FIG. 9; and FIG. 9 is a schematic diagram of port connection of a third embodiment of an LED light string circuit in the novel LED light string control system provided by the present disclosure.

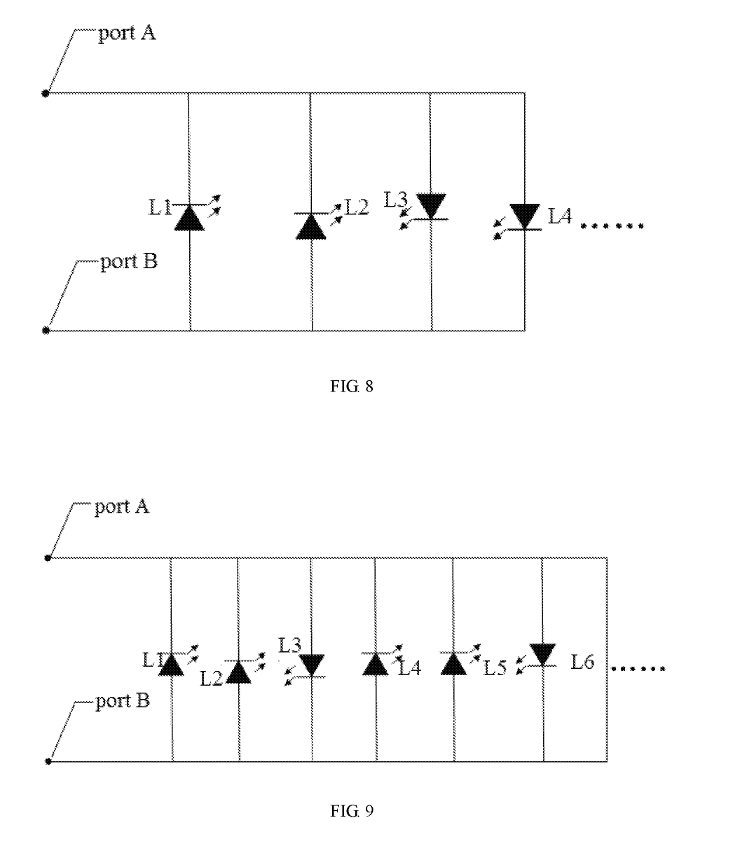

Any two adjacent LED lamp groups have opposite polarities, as shown in FIG. 8; and FIG. 8 is a schematic diagram of port connection of a second embodiment of an LED light string circuit in the novel LED light string control system provided by the present disclosure.

It should be illustrated that the number of the above-mentioned LED lamp groups may be the same or different, and the number of any one LED lamp group is not limited in the present disclosure.

Furthermore, referring to FIG. 3, which is a schematic diagram of logic connection of an embodiment of an electrodeless changeable output unit 20 in the novel LED light string control system provided by the present disclosure.

The electrodeless changeable output unit 20 comprises an instruction input module 21, an MCU 22 and a polarity voltage output port module 23, wherein the MCU 22 is respectively electrically connected with the instruction input module 21 and the polarity voltage output port module 23; the instruction input module 21 is used for outputting a control instruction and a timing sequence instruction to the MCU 22; and a power management module is used for processing received voltage of the power management unit 10 and receiving the control instruction of the MCU 22 to output changed-polarity voltages with specific frequencies to the first polarity voltage output port and the second polarity voltage output port.

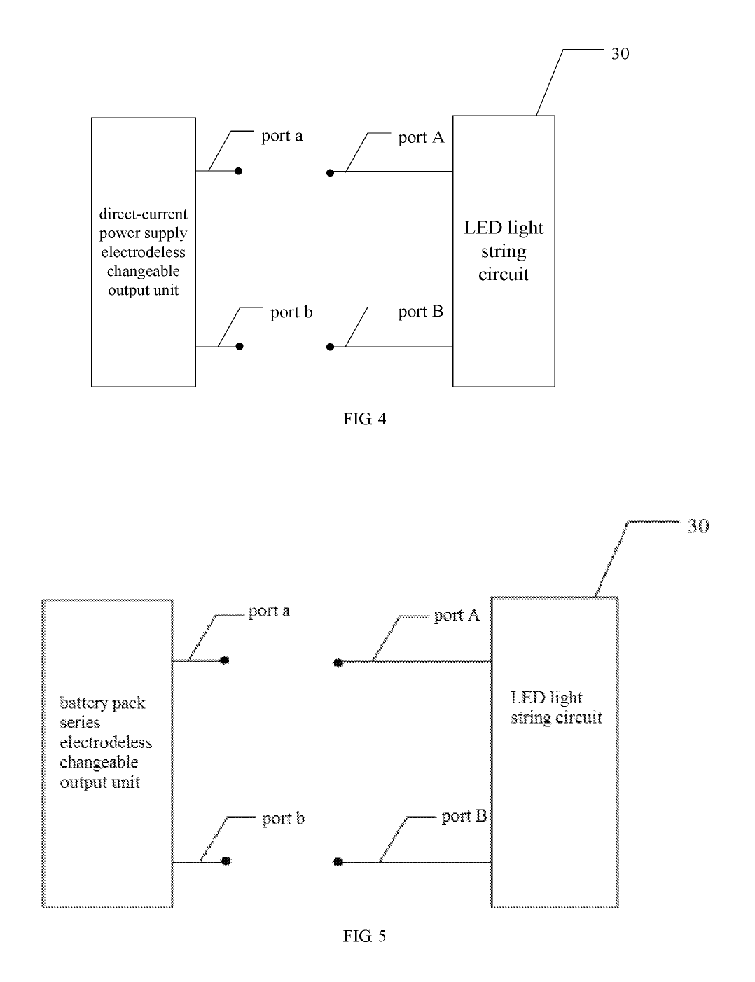

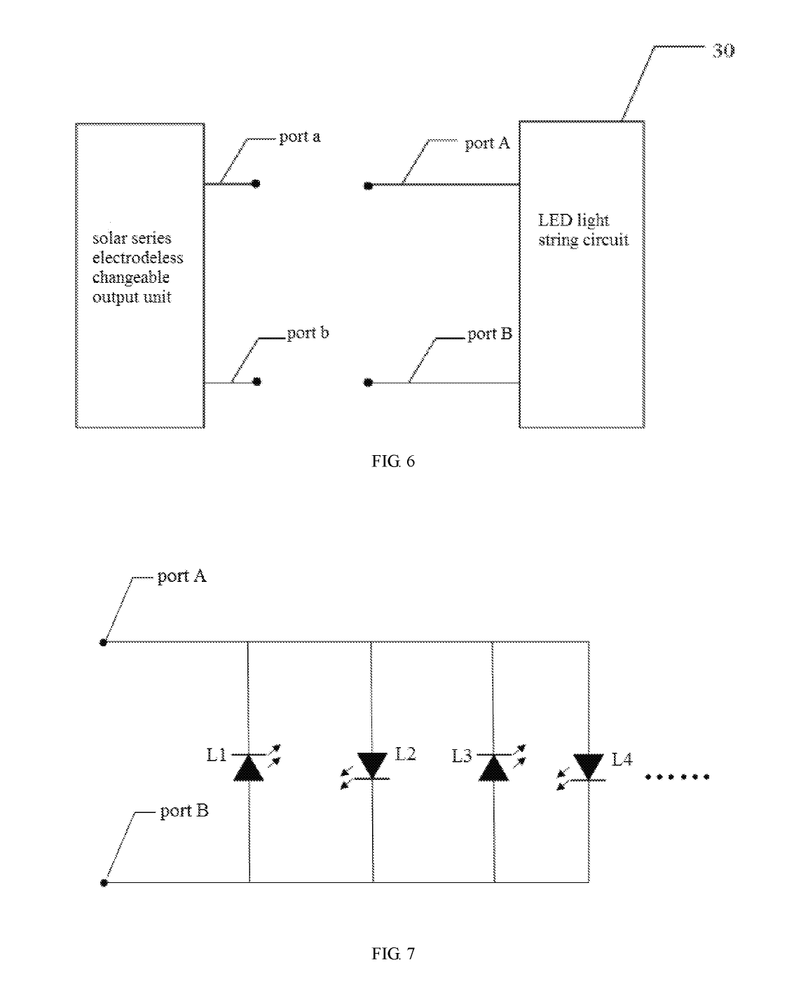

In the present disclosure, an LED lamp group forward-reverse connection method may be applied to any circuits powered by the direct-current power supply, referring to FIGS. 4 to 6, wherein FIG. 4 is a schematic diagram of port connection of an embodiment of an electrodeless changeable output unit 20 powered by a direct-current power supply in the novel LED light string control system provided by the present disclosure, FIG. 5 is a schematic diagram of port connection of an embodiment of an electrodeless changeable output unit 20 powered by a battery pack series in the novel LED light string control system provided by the present disclosure, and FIG. 6 is a schematic diagram of port connection of an embodiment of an electrodeless changeable output unit 20 powered by a solar series in the novel LED light string control system provided by the present disclosure. Specifically, the electrodeless changeable output unit 20 is any one of a direct-current power supply electrodeless changeable output unit 20, a battery pack series electrodeless changeable output unit 20 or a solar series electrodeless changeable output unit 20.

### Example 2 Method

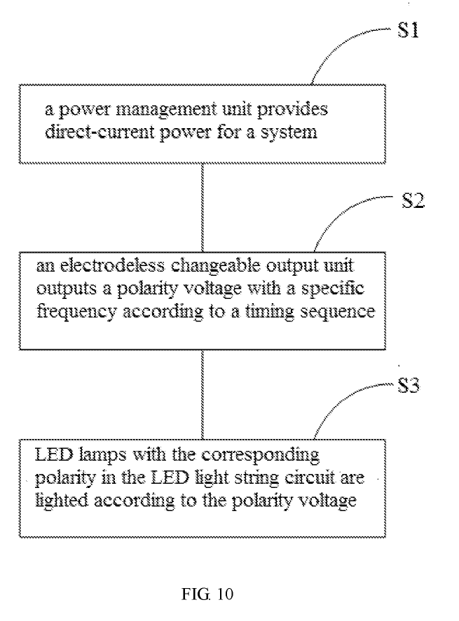

A novel LED light string control method is provided, referring to FIG. 10, and FIG. 10 is a schematic diagram of a step flow of an embodiment of a novel LED light string control method provided by the present disclosure. The method comprises the following steps.

S1, a power management unit 10 provides direct-current voltage for the system.

In the present disclosure, an LED lamp group forward-reverse connection method may be applied to any circuits powered by the direct-current power supply, and specifically, an electrodeless changeable output unit 20 is any one of a direct-current power supply electrodeless changeable output unit 20, a battery pack series electrodeless changeable output unit 20 or a solar series electrodeless changeable output unit 20.

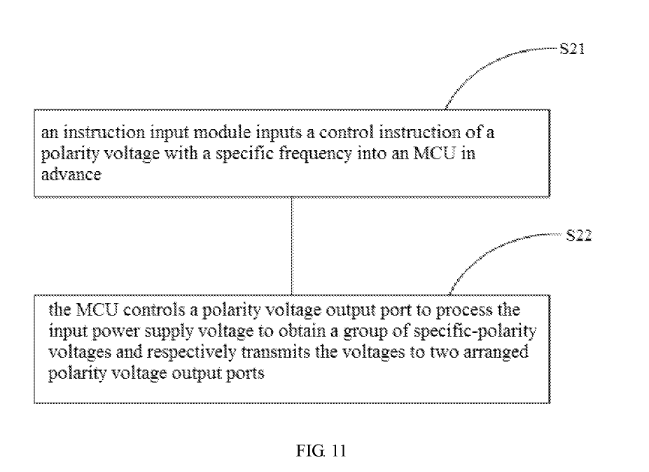

S2, the electrodeless changeable output unit 20 outputs a polarity voltage with a specific frequency according to a timing sequence. The step S2 refers to FIG. 11 which is a schematic diagram of a sub-step flow of the step S2 in the novel LED light string control method provided by the present disclosure, and the step S2 comprises:

S21, an instruction input module 21 inputs a control instruction of a polarity voltage with a specific frequency into an MCU 22 in advance; and

S22, the MCU 22 controls a polarity voltage output port 23 to process the inputted power supply voltage to obtain a group of specific-polarity voltages and respectively transmits the voltages to two arranged polarity voltage output ports.

It should be known by those skilled in the art that: in the present disclosure, the electrodeless changeable output unit 20 is used for outputting a polarity voltage with the specific frequency according to the timing sequence, the main function of the electrodeless changeable output unit 20 is to make the processed direct-current voltage generate polarity change, and because the electrodeless changeable output unit 20 is connected with the LED light string circuit, LED lamps in the LED light string circuit are lighted by the changed-polarity voltage. Therefore, any equivalent substitutions for making the unit perform the same function should all fall within the protection scope of the present disclosure.

The two polarity voltage output ports are arranged at an output end of the electrodeless changeable output unit 20, and specifically, the two polarity voltage output ports respectively are a first polarity voltage output port and a second polarity voltage output port, the polarity voltage output ports respectively are a port a and a port b, the port a and the port b are used for outputting the processed polarity voltage, and the processing may be described to process the voltage, for example, one light string circuit including multiple LED lamps needs to increase the input polarity voltage in order to meet requirements on the brightness, and the above-mentioned two output ports are correspondingly electrically connected with two input ports of the LED light string circuit.

The two input ports are arranged at an input end of the LED light string circuit, and specifically, the two polarity voltage input ports respectively are a first polarity voltage input port and a second polarity voltage input port. If supposing that the polarity voltage input ports respectively are a port A and a port B, and control wires, on which the port A and the port B are respectively located, respectively are a wire A and a wire B, the wire A and the wire B are connected. It should be known by those skilled in the art that: the wire A and the wire B are connected to form a semienclosed direct-current circuit, and the port A and the port B are two ports with different polarities. The port a and the port b are respectively and correspondingly connected with the port A and the port B.

Furthermore, the first polarity voltage input port (the port a) is arranged on a first polarity connecting wire of the LED light string circuit, the second polarity voltage input port (the port b) is arranged on a second polarity connecting wire of the LED light string circuit, the first polarity connecting wire and the second polarity connecting wire are electrically connected, and LED lamps are in parallel connection between the first polarity connecting wire and the second polarity connecting wire. The number of the LED lamps in parallel connection is larger than 2, and any two adjacent LED lamps have opposite polarities; and the LED lamps with the opposite polarities are alternatively in parallel connection in the LED light string circuit in order to achieve a changing decorative effect. In the present disclosure, forward-reverse control may be described as: any two adjacent LED lamps have opposite polarities, or any one group of LED lamps and an adjacent LED lamp have opposite polarities, or any two adjacent LED lamp groups have opposite polarities.

It should be illustrated that the number of the above-mentioned LED lamp groups may be the same or different, and the number of any one LED lamp group is not limited in the present disclosure.

Furthermore, the electrodeless changeable output unit 20 comprises the instruction input module 21, the MCU 22 and the polarity voltage output port module 23, wherein the MCU 22 is respectively electrically connected with the instruction input module 21 and the polarity voltage output port module 23; the instruction input module 21 is used for outputting a control instruction and a timing sequence instruction to the MCU 22; and a power management module is used for processing received voltage of the power management unit 10 and receiving the control instruction of the MCU 22 to output changed-polarity voltages with specific frequencies to the first polarity voltage output port and the second polarity voltage output port.

S3, according to the polarity voltage, LED lamps with the corresponding polarity in the LED light string circuit are lighted, wherein the two polarity voltage output ports are arranged at the output end of the electrodeless changeable output unit 20, two polarity voltage input ports are arranged at the input end of the LED light string circuit, and the polarity comprises two polarities, namely a positive polarity and a negative polarity.

According to implementation of the novel LED light string control system and method provided by the present disclosure, the electrodeless changeable output unit 20 is configured to output the specific-polarity voltage to the LED light string circuit according to the timing sequence instruction, two adjacent LED lamps in the LED light string circuit have opposite polarities so as to form a forward-reverse connection circuit, and after the LED light string circuit obtains the specific-polarity voltage, the LED lamps with the corresponding polarity are lighted. An LED light string forward-reverse connection circuit provided by the present disclosure replaces the traditional multiple-wire LED light string circuit and has the advantages that the production procedure is simplified, production costs are largely reduced, the structure is simple, and maintenance is convenient. When sweep frequency for the changed polarity according to the timing sequence is larger than 24 Hz, that is, LED lamps with all polarities are lighted at the same time, a decorative effect of the LED light string circuit is achieved.

The embodiments of the present disclosure are described above in conjunction with accompanying drawings, but the present disclosure is not limited to the above specific implementation manners, and the above specific implementation manners merely are illustrative but not restrictive. These ordinarily skilled in the art may further make various forms under the enlightenment of the present disclosure without departing from the purposes of the present disclosure and the protection scope of the appended claims, and those forms all fall within the protection scope of the present disclosure.

1. An LED light string control system comprising a power management unit and a changeable output unit and an LED light string circuit,
wherein the changeable output unit is electrically connected with the power management unit and the LED light string circuit, the power management unit is capable of providing direct-current voltage for the control system, the changeable output unit is capable of outputting a polarity voltage with a specific frequency to the LED light string circuit according to a timing sequence, wherein two polarity voltage output ports are arranged at an output end of the changeable output unit, two polarity voltage input ports are arranged at an input end of the LED light string circuit, and the polarity comprises a positive polarity and a negative polarity.

2. The LED light string control system of claim 1, wherein the two polarity voltage output ports are a first polarity voltage output port and a second polarity voltage output port, the two polarity voltage input ports are a first polarity output input port and a second polarity voltage input port, and the first polarity voltage output port and the second polarity voltage output port are electrically connected with both the first polarity input port and the second polarity input port.

3. The LED light string control system of claim 2, wherein the first polarity voltage input port is arranged on a first polarity connecting wire of the LED light string circuit, the second polarity voltage input port is arranged on a second polarity connecting wire of the LED light string circuit, the first polarity connecting wire is electrically connected with the second polarity connecting wire, and a plurality of LED lamps are in parallel connection with the first polarity connecting wire and the second polarity connecting wire and connected among themselves.

4. The LED light string control system of claim 3, wherein the LED lamps have a number larger than 2.

5. The LED light string control system of claim 1, wherein two adjacent LED lamps have opposite polarities.

6. The LED light string control system of claim 1, wherein the changeable output unit comprises an instruction input module, an MCU and a polarity voltage output port module, the MCU is electrically connected with both the instruction input module and the polarity voltage output port module, the instruction input module is capable of outputting a control instruction and a timing sequence instruction to the MCU, and the MCU controls the polarity voltage output port module to output changed-polarity voltages with specific frequencies to the first polarity voltage output port and the second polarity voltage output port.

7. The LED light string control system of claim 1, wherein changeable output unit is one selected from the group consisting of a direct-current power supply changeable output unit, a battery pack series changeable output unit and a solar series changeable output unit.

8. An LED light string control method comprising:
a power management unit providing a direct-current voltage for a system;
a changeable output unit outputting a polarity voltage with a specific frequency according to a timing sequence; and
an LED lamp with the corresponding polarity in the LED light string circuit being lighted according to the polarity voltage, wherein two polarity voltage output ports are arranged at an output end of the changeable output unit, two polarity voltage input ports are arranged at an input end of the LED light string circuit, and the polarity comprises a positive polarity and a negative polarity.

9. The LED light string control method of claim 8, wherein the step of a changeable output unit outputting a polarity voltage with a specific frequency according to a timing sequence comprises:
an instruction input module inputting a control instruction of a polarity voltage with a specific frequency into the MCU in advance; and
the MCU controlling the polarity voltage output port to process the inputted power supply voltage to obtain a group of specific-polarity voltages and transmitting the voltages to the two polarity voltage output ports respectively.
